(19) United States
(12) Patent Application Publication
(10) Pub. No.: US 2015/0130272 A1
(43) Pub. Date: May 14, 2015

(54) WIRELESS POWER RECEIVING APPARATUS AND CONTROL METHOD FOR SUCH APPARATUS

(71) Applicant: PIONEER CORPORATION, Kanagawa (JP)

(72) Inventors: Masami SUZUKI, Kanagawa (JP); Eiichi URUSHIBATA, Kanagawa (JP); Keisuke IWAWAKI, Kanagawa (JP)

(21) Appl. No.: 14/568,470

(22) Filed: Dec. 12, 2014

Related U.S. Application Data
(62) Division of application No. 14/346,153.

(51) Int. Cl. H02J 5/00; H02J 17/00; B60L 11/18

(52) U.S. Cl. CPC H02J 5/005; B60L 11/182; H02J 17/00
USPC 307/9.1; 307/104

(57) ABSTRACT

A wireless power transmitting apparatus (10) is a wireless power transmitting apparatus which transmits electric power in a wireless manner by electromagnetic induction to a power receiving apparatus (20) which is provided with a power reception coil (220) and a fixed capacitance capacitor (230) electrically connected in parallel with the power reception coil. The wireless power transmitting apparatus is provided with: an alternating current power supply (110) which generates alternating current power; a power transmission coil (120) which is electrically connected to the alternating current power supply; a variable capacitance capacitor (130) which is electrically connected in series with the power transmission coil; and a capacitance controlling device (140) which controls a capacitance value of the variable capacitance capacitor to reduce a phase difference between a voltage phase and a current phase of the alternating current power.

### TECHNICAL FIELD

The present invention relates to a wireless power transmitting apparatus, a wireless power receiving apparatus, and a wireless power feeding system which transmit and receive electric power in a wireless manner.

### BACKGROUND ART

As this type of apparatus, there is proposed, for example, a wireless feeding apparatus which is provided with a serial capacitor electrically connected in series with a primary coil (or a power transmission coil) driven by an alternating current power supply, and a parallel-connected capacitor electrically connected in parallel with a secondary coil (or a power reception coil). This is referred to as a primary serial and secondary parallel resonance capacitor type. In this type, a capacitance value Cp of the parallel-connected capacitor on the secondary side is set to a value which resonates With the sum of excitation reactance x₀ and leakage reactance x₂ on the secondary side at drive frequency of a power supply (ω₀) (Equation 1), and a capacitance value Cs of the serial capacitor on the primary side is set such that a primary side power factor is 1 at the drive frequency (Equation 2) (refer to Patent document 1).

$$\begin{matrix}\frac{1}{{ω}_{0} Cp} = {x}_{0} + {x}_{2} & ( Equation 1 ) \\ \frac{1}{{ω}_{0} Cs} = \frac{{x}_{0} {x}_{1} + {x}_{1} {x}_{2} + {x}_{2} {x}_{0}}{{x}_{0} + {x}_{2}} & ( Equation 2 )\end{matrix}$$

Alternatively, there is proposed an apparatus in which a power receiving circuit is provided with a fixed capacitance resonance capacitor and a variable capacitance capacitor whose capacitance changes at a switching time rate, in order to perform correction if inductance of the power receiving circuit changes (refer to Patent document 2).

### PRIOR ART DOCUMENT

### Patent Document

Patent document 1: International Publication No. 2007/029438
Patent document 2: Japanese Patent Application Laid Open No. 2004-72832

### DISCLOSURE OF INVENTION

### Subject to be Solved by the Invention

If the technologies described in the Patent documents 1 and 2 are applied, for example, to the charging of a battery disposed in an electric vehicle, typically, the power feeding side circuit (or the primary coil) is embedded in the ground, and the power receiving side (or the secondary coil) is disposed in a lower part of the electric vehicle. Thus, a distance between the power feeding side circuit and the power receiving side circuit varies depending on the height of the electric vehicle. Moreover, there is a possibility that there may be a horizontal positional deviation between the power feeding side circuit and the power receiving side circuit due to a position at which a driver stops the electric vehicle.

In the technology described in the Patent document 1, the aforementioned equations (1) and (2) for setting the capacitance value Cp of the parallel-connected capacitor and the capacitance value Cs of the serial capacitor are transformed into the following equations (3) and (4) by using respective self-inductances L1 and L2 of the primary coil and the secondary coil and a mutual inductance Lm between of the primary coil and the secondary coil. This transformation uses a relation of Lₘ=k√(L₁×L₂), wherein k is a coefficient (i.e. a coupling coefficient) which represents the degree of magnetic coupling between the primary coil and the secondary coil.

$$\begin{matrix}\frac{1}{{ω}_{0} Cp} = {x}_{0} + {x}_{2} = {ω}_{0} {L}_{m} + {ω}_{0} ( {L}_{2} - {L}_{m} ) = {ω}_{0} {L}_{2} & ( Equation 3 ) \\ \begin{matrix}\frac{1}{{ω}_{0} Cp} = \frac{{x}_{0} {x}_{1} + {x}_{1} {x}_{2} + {x}_{2} {x}_{0}}{{x}_{0} + {x}_{2}} \\ = \frac{\begin{matrix}{ω}_{0}^{2} {L}_{m} ( {L}_{1} - {L}_{m} ) {ω}_{0}^{2} ( {L}_{1} - {L}_{m} ) \\ ( {L}_{2} - {L}_{m} ) + {ω}_{0}^{2} ( {L}_{2} - {L}_{m} ) {L}_{m}\end{matrix}}{{ω}_{0} {L}_{2}} \\ = {ω}_{0} {L}_{1} ( 1 - {k}^{2} )\end{matrix} & ( Equation 4 )\end{matrix}$$

From the (Equation 3), it is found that the capacitance value Cp of the parallel-connected capacitor is determined by the self-inductance L2 of the secondary coil and the drive frequency of the power supply. On the other hand, from the (Equation 4), it is found that the capacitance value Cs of the serial capacitor depends on the coupling coefficient k between the primary coil and the secondary coil, in addition to the self-inductance L1 of the primary coil and the drive frequency. Therefore, when the capacitance value Cs of the serial capacitor is fixed to a particular design value, there is such a technical problem that power supply efficiency likely remarkably decreases due to a change in the coupling coefficient between the primary coil and the secondary coil if the distance between the power feeding side circuit and the power receiving side circuit deviates from its design value or if there is the horizontal positional deviation between the power feeding side circuit and the power receiving side circuit, as described in the case where the technology is applied to the charging of the battery disposed in the electric vehicle. On the other hand, as in the technology described in the aforementioned Patent document 2, when the power receiving side circuit is provided with the variable capacitance capacitor which is electrically connected in parallel with the coil, there is such a technical problem that utilization efficiency of the power supply of the power feeding side circuit likely decreases.

In view of the aforementioned problems, it is therefore an object of the present invention to provide a wireless power transmitting apparatus, a wireless power receiving apparatus, and a wireless power feeding system which are configured to efficiently perform power transmission without depending on the distance between the power feeding side circuit and the power receiving side circuit and even despite the horizontal positional deviation between the power feeding side circuit and the power receiving side circuit.

### Means for Solving the Subject

The above object of the present invention can be solved by a wireless power transmitting apparatus which transmits electric power in a wireless manner by electromagnetic induction to a power receiving apparatus, the power receiving apparatus comprising a power reception coil and a fixed capacitance capacitor which is electrically connected in parallel with the power reception coil, said wireless power transmitting apparatus is provided with an alternating current power supply which generates alternating current power, a power transmission coil which is electrically connected to the alternating current power supply, a variable capacitance capacitor which is electrically connected in series with the power transmission coil, and a capacitance controlling device which controls a capacitance value of the variable capacitance capacitor to reduce a phase difference between a voltage phase and a current phase of the alternating current power. In other words, the wireless power transmitting apparatus is a wireless power transmitting apparatus which constitutes a so-called primary serial and secondary parallel resonance capacitor type wireless power feeding system.

Here, the capacitance value of the fixed capacitance capacitor in the power receiving apparatus is determined to resonate with the self-inductance of the power reception coil at the drive frequency. On the other hand, the capacitance value of the serial capacitor which is electrically connected in series with the power transmission coil in the power transmitting apparatus is determined such that a power factor on the power transmitting apparatus side (i.e. on the primary side) is 1 at the drive frequency (refer to the Equation 1).

An optimal value of the capacitance value of the serial capacitor varies depending on the extent of magnetic coupling (or the coupling coefficient) between the power transmission coil and the power reception coil (refer to the Equation 4). In this case, even if the capacitance value of the serial capacitor is determined such that the power factor on the power transmitting apparatus side is 1 at the drive frequency while a distance between the power transmission coil and the power reception coil is set to a particular value, the power factor becomes less than 1 (i.e. the utilization efficiency of the power supply decreases) if an actual distance between the power transmission coil and the power reception coil deviates from the particular value, or if there is a horizontal positional deviation between the power transmission coil and the power reception coil.

Therefore, in the present invention, the variable capacitance capacitor is electrically connected in series with the power transmission coil, and the capacitance value of the variable capacitance capacitor is controlled to reduce the phase difference between the voltage phase and the current phase of the alternating current power (i.e. such that the power factor approaches 1) by the capacitance controlling device which is provided, for example, with a memory, a processor or the like.

As a result, according to the wireless power transmitting apparatus of the present invention, the power transmission can be efficiently performed even if the distance between the power transmission coil and the power reception coil changes or there is the horizontal positional deviation, i.e. even if the extent of the coupling or the coupling coefficient) between the power transmission coil and the power reception coil changes.

In one aspect of the wireless power transmitting apparatus of the present invention, said wireless power transmitting apparatus further comprises a coupling estimating device which estimates extent of magnetic coupling between the power transmission coil and the power reception coil, and the capacitance controlling device controls the capacitance value of the variable capacitance capacitor on the basis of the estimated extent of the magnetic coupling.

According to this aspect, the coupling estimating device which is provided, for example, a memory, a processor or the like estimates the extent of the magnetic coupling (or the coupling coefficient) between the power transmission coil and the power reception coil. According to this aspect, the capacitance value of the variable capacitance capacitor can be controlled to reduce the phase difference between the voltage phase and the current phase of the alternating current power, because the optimal capacitance value of the serial capacitor depends on the coupling coefficient as shown in the (Equation 4).

In an aspect in which the coupling estimating device is provided, the coupling estimating device has a distance measuring device which measures a distance between the power transmission coil and the power reception coil, and a converting device which stores therein in advance a correspondence between the distance and a coupling coefficient for indicating the extent of the magnetic coupling, and which converts the measured distance to the coupling coefficient on the basis of the stored correspondence.

By virtue of such a configuration, the extent of the magnetic coupling can be estimated, relatively easily, which is extremely useful in practice.

Alternatively, in an aspect in which the coupling estimating device is provided, the coupling estimating device has an obtaining device Which obtains at least one of a power reception side voltage value and a power reception Side current value of the power receiving apparatus, a detecting device which detects at least a power transmission side voltage value, which is a voltage value of the alternating current power, and a power transmission side current value, which is a current value of the alternating current power, a calculating device which calculates power transmission efficiency on the basis of the obtained at least one of the power reception side voltage value and the power reception side current value, and the detected at least one of the power transmission side voltage value and the power transmission side current value, and a converting device which stores therein in advance a correspondence between the power transmission efficiency and a coupling coefficient for indicating the extent of the magnetic coupling, and which converts the calculated power transmission efficiency to the coupling coefficient on the basis of the stored correspondence.

By virtue of such a configuration, the extent of the magnetic coupling can be estimated, relatively easily; which is extremely useful in practice.

Alternatively, in an aspect in which the coupling estimating device is provided, the power receiving apparatus is disposed in a moving body, and the coupling estimating device has a type obtaining device which obtains a type of the moving body, and a converting device which stores therein in advance a correspondence between the type and a coupling coefficient for indicating the extent of the magnetic coupling, and which converts the obtained type to the coupling coefficient on the basis of the stored correspondence.

By virtue of such a configuration, the extent of the magnetic coupling can be estimated, relatively easily, when the wireless power transmitting apparatus is applied to the moving body such as, for example, an electric vehicle.

Alternatively; in an aspect in which the coupling estimating device is provided, the coupling estimating device has a distance measuring device which measures a distance between the power transmission coil and the power reception coil, a positional deviation amount detecting device which detects a positional deviation amount of the power transmission coil to the power reception coil in a direction along a surface of the power transmission coil opposed to the power reception coil, and a converting device which stores therein in advance a correspondence of the distance and the positional deviation amount with a coupling coefficient for indicating the extent of the magnetic coupling, and which converts the measured distance and the detected positional deviation amount to the coupling coefficient on the basis of the stored correspondence.

By virtue of such a configuration, the extent of the magnetic coupling can be estimated, relatively easily, which is extremely useful in practice.

In another aspect of the wireless power transmitting apparatus of the present invention, said wireless power transmitting apparatus is further provided with a voltage phase detecting device which detects the voltage phase of the alternating current power, and a current phase detecting device which detects the current phase of the alternating current power, and the capacitance controlling device controls the capacitance value of the variable capacitance capacitor to reduce a phase difference between the detected voltage phase and the detected current phase.

According to this aspect, the capacitance value of the variable capacitance capacitor can be controlled to reduce the phase difference between the voltage phase and the current phase of the alternating current power, relatively easily.

In another aspect of the wireless power transmitting apparatus of the present invention, said wireless power transmitting apparatus further comprises a coupling coefficient calculating device which calculates a coupling coefficient between the power transmission coil and the power reception coil, and the capacitance controlling device controls the capacitance value of the variable capacitance capacitor on the basis of the calculated coupling coefficient.

According to this aspect, the capacitance value of the variable capacitance capacitor can be controlled to reduce the phase difference between the voltage phase and the current phase of the alternating current power, relatively easily.

The above object of the present invention can be solved by a wireless power receiving apparatus which receives electric power in a wireless manner by electromagnetic induction from a power transmitting apparatus, the power transmitting apparatus comprising an alternating current power supply which generates an alternating current power, a power transmission coil which is electrically connected to the alternating current power supply, and a fixed capacitance capacitor which is electrically connected in parallel with the power transmission coil, said power receiving apparatus is provided with a power reception coil, a variable capacitance capacitor which is electrically connected in series with the power reception coil, and a capacitance controlling device which controls a variable value of the variable capacitance capacitor to reduce a phase difference between a voltage phase and a current phase of the alternating current power. In other words, wireless power receiving apparatus is a wireless power receiving apparatus which constitutes a so-called primary serial and secondary parallel resonance capacitor type wireless power feeding system.

Particularly in the wireless power receiving apparatus of the present invention, the capacitance value of the variable capacitance capacitor is controlled to reduce the phase difference between the voltage phase and the current phase of the alternating current power of the power transmitting apparatus (i.e. such that the power factor on the power transmitting apparatus side is 1), by the capacitance controlling device. As a result, according to the wireless power receiving apparatus of the present invention, the power transmission can be efficiently performed even if the extent of the magnetic coupling (the coupling coefficient) between the power transmission coil and the power reception coil changes.

Incidentally, even the wireless power receiving apparatus of the present invention can adopt the same various aspects as those of the wireless power transmitting apparatus of the present invention described above.

The above object of the present invention can be solved by a wireless power feeding system comprising an alternating current power supply which generates an alternating current power, a power transmission coil which is electrically connected to the alternating current power supply, and a power reception coil which receives electric power in a wireless manner by electromagnetic induction from the power transmission coil, said wireless power feeding system is provided with a fixed capacitance capacitor which is electrically connected in parallel with one of the power transmission coil and the power reception coil, a variable capacitance capacitor which is electrically connected in series with the other one of the power transmission coil and the power reception coil, and a capacitance controlling device which controls a capacitance value of the variable capacitance capacitor to reduce a phase difference between a voltage phase and a current phase of the alternating current power.

According to the wireless power feeding system of the present invention, as in the wireless power transmitting apparatus and the wireless power receiving apparatus of the present invention described above, the power transmission can be efficiently performed even if the extent of the magnetic coupling (or the coupling coefficient) between the power transmission coil and the power reception coil changes.

Incidentally, even the wireless power feeding system of the present invention can adopt the same various aspects as those of the wireless power transmitting apparatus of the present invention described above.

The operation and other advantages of the present invention will become more apparent from embodiments explained below.

### BRIEF DESCRIPTION OF DRAWINGS

FIG. 1 is a block diagram illustrating a configuration of a wireless power feeding system in a first embodiment.

FIG. 2 is a conceptual diagram illustrating one example of a variable capacitance capacitor in the first embodiment.

FIG. 3 is a circuit diagram illustrating a configuration of a wireless power feeding system in a comparative example.

FIG. 4 is a graph illustrating one example of each of time variations in primary side voltage V₁, secondary side voltage V₂, primary side current I₁ and secondary side current I₂.

FIG. 5 is to graph illustrating another example of each of time variations in primary side voltage V₁, secondary side voltage V₂, primary side current I₁ and secondary side current I₂.

FIG. 6 is a graph illustrating another example of each of time variations in primary side voltage V₁, secondary side voltage V₂, primary side current I₁ and secondary side current I₂.

FIG. 7 is a characteristic diagram illustrating one example of a relation between a coupling coefficient and power supply effective utilization efficiency.

FIG. 8 is a graph illustrating another example of each of time variations in primary side voltage V₁, secondary side voltage V₂, primary side current I₁ and secondary side current I₂.

FIG. 9 is a graph illustrating another example of each of time variations in primary side voltage V₁, secondary side voltage V₂, primary side current I₁ and secondary side current I₂.

FIG. 10 is a block diagram illustrating a configuration of a wireless power feeding system in a second embodiment.

FIG. 11 is a block diagram illustrating a configuration of a wireless power feeding system in a third embodiment.

FIG. 12 is a block diagram illustrating a configuration of a wireless power feeding system in a fourth embodiment.

FIG. 13 is a block diagram illustrating a configuration of a wireless power feeding system in a fifth embodiment.

FIG. 14 is a block diagram illustrating a configuration of a wireless power feeding system in a sixth embodiment.

FIG. 15 is a block diagram illustrating a configuration of a wireless power feeding system in a seventh embodiment.

### MODES FOR CARRYING OUT THE INVENTION

Hereinafter, embodiments of the wireless power feeding system of the present invention will be explained with reference to the drawings. The following drawings illustrate only members directly related to the present invention, and the illustration of other members is omitted.

### First Embodiment

A first embodiment of the wireless power feeding system of the present invention will be explained with reference to FIG. 1 to FIG. 9.

### (Configuration of Wireless Power Feeding System)

A configuration of a wireless power feeding system in the first embodiment will be explained with reference to FIG. 1. FIG. 1 is a block diagram illustrating the configuration of the wireless power feeding system in the first embodiment.

In FIG. 1, a wireless power feeding system 1 is provided with a power transmitting apparatus 10 and a power receiving apparatus 20.

The power transmitting apparatus 10 is provided with (i) a power transmission circuit 110 including an alternating current power supply which generates alternating current power (not illustrated), (ii) a power transmission coil 120 electrically connected to the power transmission circuit 110, (iii) a variable capacitance capacitor 130 electrically connected in series with the power transmission coil 120, (iv) a capacitance control unit 140 which controls a capacitance value of the variable capacitance capacitor 130, and (v) a coupling coefficient estimation unit 150 which estimates a coupling coefficient which indicates the extent of coupling between the power transmission coil 120 and a power reception coil 220 described later.

The coupling coefficient estimation unit 150 is provided with a distance sensor 151 which measures a distance between the power transmission coil 120 and the power reception coil 220, and a distance-coupling coefficient conversion unit 152 which converts the distance measured by the distance sensor 151, to the coupling coefficient.

Here, the distance-coupling coefficient conversion unit 152 stores therein information which indicates a correspondence between the distance and the coupling coefficient, in advance. Then, the distance-coupling coefficient conversion unit 152 converts the distance measured by the distance sensor 151, to the coupling coefficient, on the basis of the information which indicates the correspondence between the distance and the coupling coefficient. The information which indicates the correspondence between the distance and the coupling coefficient may be established, for example, on the basis of a relation of the distance between the power transmission coil 120 and the power reception coil 220 with self-inductance and leakage inductance of the power transmission coil 120, wherein the relation is obtained by experiments or simulations.

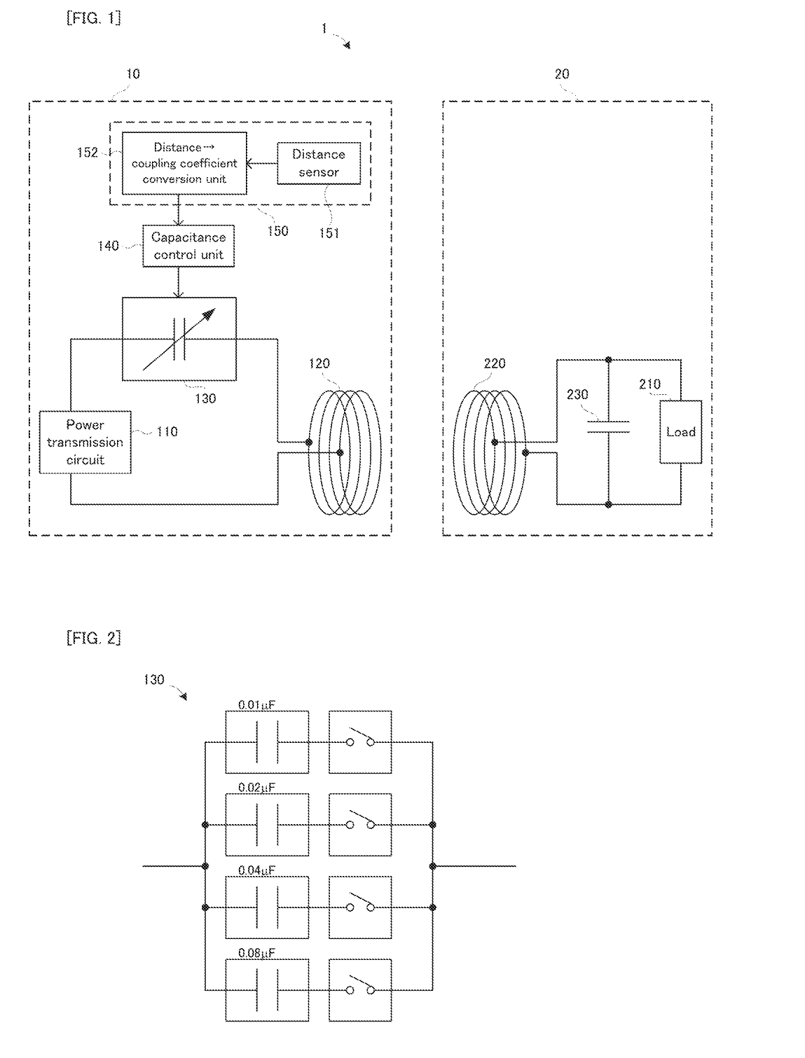

The variable capacitance capacitor 130 is configured to perform parallel addition of a plurality of fixed capacitance capacitors by using switching elements, far example, as illustrated in FIG. 2. By virtue of such a configuration, it can vary for example, from 0.01 μF (microfarad) to 0.15 μF at intervals of 0.01 μF. FIG. 2 is a conceptual diagram illustrating one example of the variable capacitance capacitor in the first embodiment.

The variable capacitance capacitor 130 may not be limited to have the configuration illustrated in FIG. 2 but may be provided with, for example, a capacitor which can change electrostatic capacitance by rotating its rotating shaft (a so-called variable capacitor) and a stepping motor which rotates the rotating shaft of the capacitor.

Back in FIG. 1 again, the power receiving apparatus 20 is provided with a load 210 such as, for example, a battery a power reception coil 220 electrically connected to the load 210, and a fixed capacitance capacitor 230 electrically connected in parallel with the power reception coil 220.

### Effect of the Invention

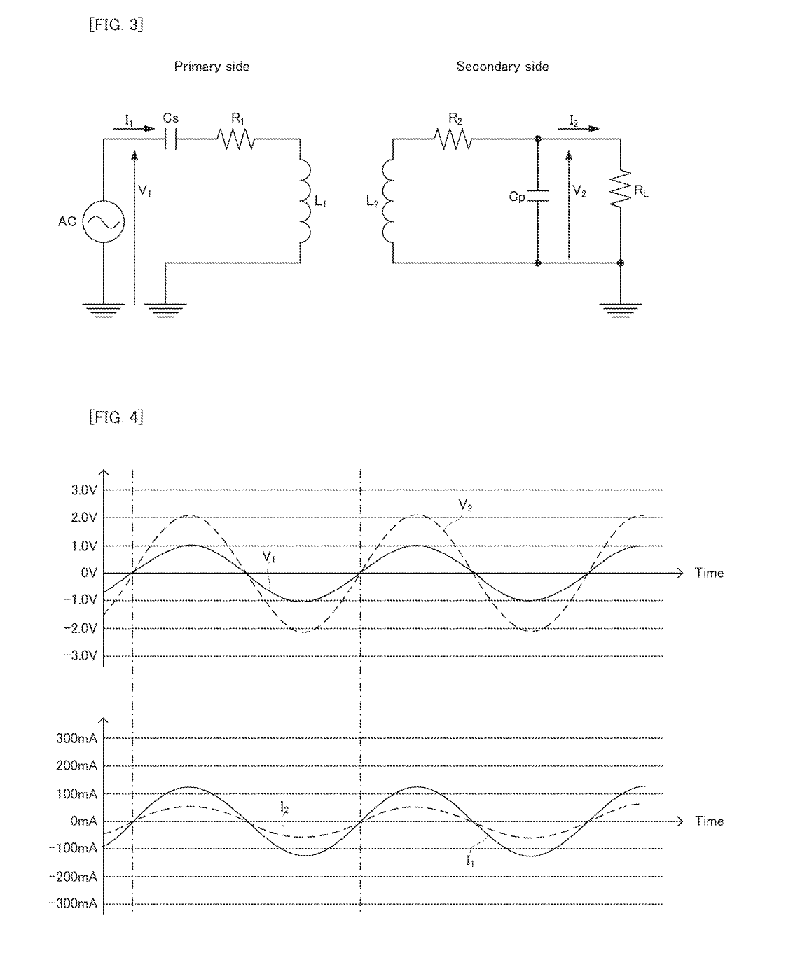

Next, an effect of the variable capacitance capacitor 130 being electrically connected in series with the power transmission coil 120 will be explained with reference to FIG. 3 to FIG. 9. FIG. 3 is a circuit diagram illustrating a configuration of a wireless power feeding system in a comparative example.

In FIG. 3, a primary side (i.e. a power transmitting apparatus) is provided with an alternating current power supply AC, a primary coil L₁ electrically connected to the alternating current power supply AC, and a serial capacitor Cs electrically connected in series with the primary coil L₁. It is assumed that primary side loss resistance is R₁.

On the other hand, a secondary side (i.e. a power receiving apparatus) is provided with load resistance R_{L}, a secondary coil L₂ electrically connected to the load resistance R_{L}, and a parallel-connected capacitor Cp electrically connected in parallel with the primary coil L₂. It is assumed that secondary side loss resistance is R₂.

If both of the serial capacitor Cs and the parallel-connected capacitor Cp are fixed capacitance capacitors, the capacitance value of the parallel-connected capacitor Cp is firstly determined according to the aforementioned (Equation 3) on the basis of the drive frequency of the power supply and the self-inductance L₂ of the secondary coil. Then, the capacitance value of the serial capacitor Cs is determined according to the aforementioned (Equation 4) by measuring the mutual inductance or the coupling coefficient after setting a distance between the primary coil and the secondary coil at a predetermined value.

When the capacitance value of the parallel-connected capacitor Cp and the capacitance value of the serial capacitor Cs are determined according to the (Equation 3) and (Equation 4), a primary side power factor can be set: equal to 1 (i.e. primary side power factor=1). If an inverter is used for the power transmission circuit, a soft switching method is sometimes adopted for the purpose of reducing a switching loss. In this case, the power factor is sometimes slightly shifted from 1 on purpose in practice. In the present invention, the expression “such that the power factor=1” is used; however, allowing implementation with the shift or deviation of that level is included in the present invention.

Now it is assumed that each of the capacitance values of the serial capacitor Cs and the parallel-connected capacitor Cp is determined in a case where the coupling coefficient between the primary coil L₁ and the secondary coil L₂ is 0.46 (corresponding to a case where the distance between the primary coil L₁ and the secondary coil L₂ is 10 cm (centimeters). If the drive frequency of the power supply is 95 kHz and each of the respective self-inductances L₁ and L₂ of the primary coil and the secondary coil is 36 μH, then, Cs=0.1 μF and Cp=0.078 μF.

In the wireless power feeding system in the comparative example as configured above, if the distance between the primary coil L₁ and the secondary coil L₂ is 10 cm (i.e. the coupling coefficient is 0.46), each of time variations in primary side voltage V₁, secondary side voltage V₂, primary side current I₁ and secondary side current I₂ is, for example, as illustrated in FIG. 4. An upper part of FIG. 4 illustrates one example of each of the time variations in primary side voltage V₁ and secondary side voltage V₂, and a lower part of FIG. 4 illustrates one example of each of the time variations in primary side current I₁ and secondary side current I₂.

A point to note in FIG. 4 is that the phase of the primary side voltage V₁ matches the phase of the primary side current I₁ and that the primary side power factor is 1. Thus, power supply effective utilization efficiency (i.e. secondary side effective power primary apparent power×100) is 95.1%.

In the wireless power feeding system in the comparative example, if the distance between the primary coil L₁ and the secondary coil L₂ is greater than 10 cm and the coupling coefficient is 0.2, each of the time variations in primary side voltage V₁, secondary side voltage V₂, primary side current I₁ and secondary side current I₂ is, for example, as illustrated in FIG. 5. An upper part of FIG. 5 illustrates another example of each of the time variations in primary side voltage V₁ and secondary side voltage V₂, to the same effect as in the upper part of FIG. 4, and a lower part of FIG. 5 illustrates another example of each of the time variations in primary side current I₁ and secondary side current I₂, to the same effect as in the lower part of FIG. 4.

A point to note in FIG. 5 is that the phase of the primary side current I₁ is delayed from the phase of the primary side voltage V₁ by about 65 degrees. Thus, the primary side power factor drops to 0.41, and the power supply effective utilization efficiency drops to 34.7%.

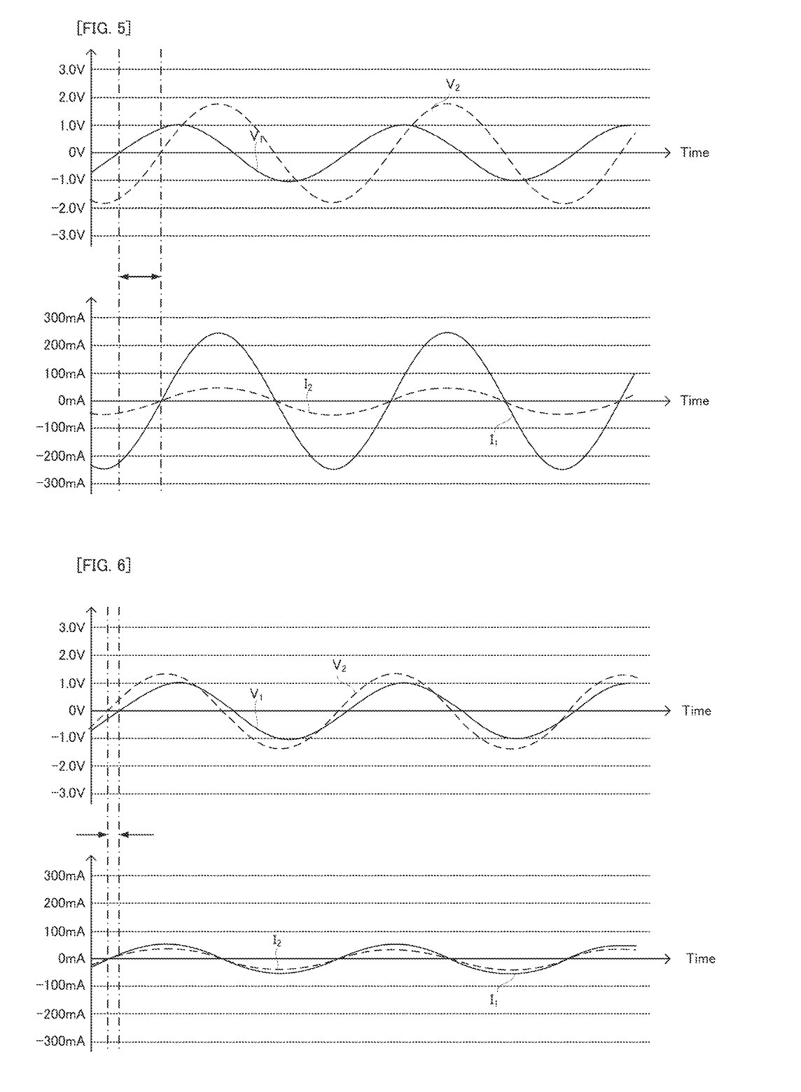

Alternatively, in the wireless power feeding system in the comparative example, if the distance between the primary coil L₁ and the secondary coil L₂ is less than 10 cm and the coupling coefficient is 0.7, each of the time variations in primary side voltage V₁, secondary side voltage V₂, primary side current I₁ and secondary side current I₂ is, for example, as illustrated in FIG. 6. An upper part of FIG. 6 illustrates another example of each of the time variations in primary side voltage V₁ and secondary side voltage V₂, to the same effect as in the upper part of FIG. 4, and a lower part of FIG. 6 illustrates another example of each of the time variations in primary side current I₁ and secondary side current I₂, to the same effect as in the lower part of FIG. 4.

A point to note in FIG. 6 is that the phase of the primary side current I₁ is advanced from the phase of the primary side voltage V₁ by about 17 degrees. Thus, the primary side power factor decreases to 0.96, and the power supply effective utilization efficiency decreases to 923%.

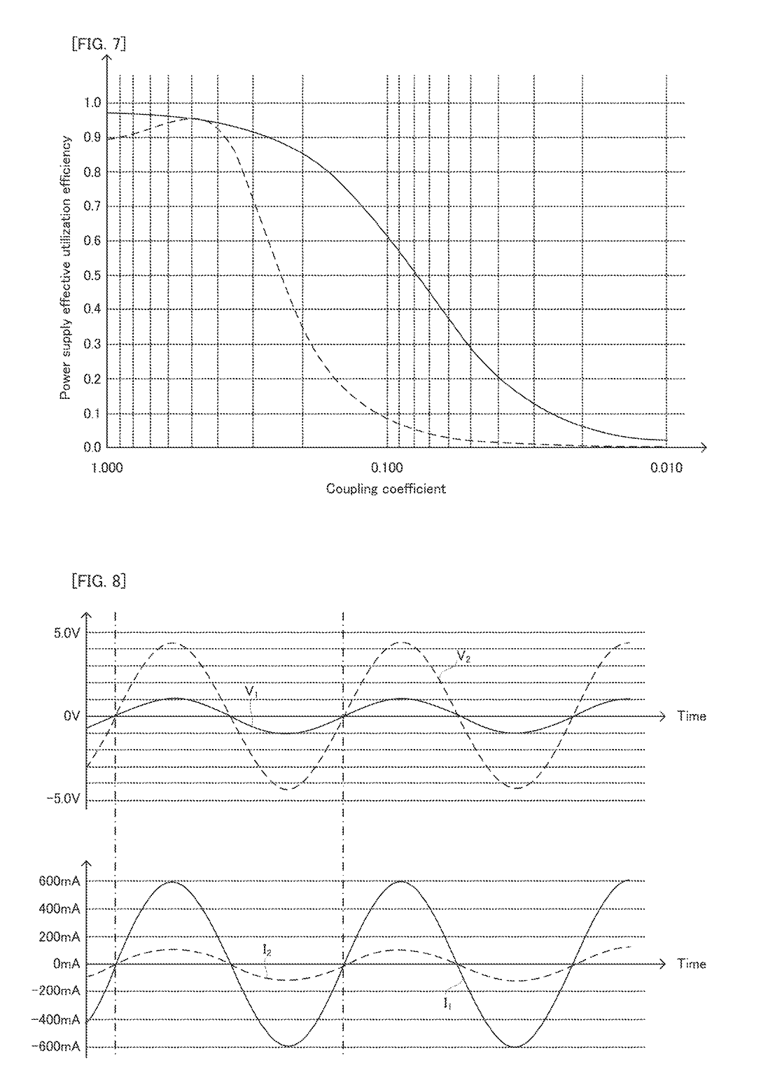

A relation between the coupling coefficient and the power supply effective utilization efficiency is illustrated in FIG. 7. FIG. 7 is a characteristic diagram illustrating one example of the relation between the coupling coefficient and the power supply effective utilization efficiency. In FIG. 7, a solid line illustrates one example of the relation between the coupling coefficient and the power supply effective utilization efficiency in the wireless power feeding system in the embodiment, and a dashed line illustrates one example of the relation between the coupling coefficient and the power supply effective utilization efficiency in the wireless power feeding system in the comparative example.

If the wireless power feeding system is applied, for example, to a charging system of a battery disposed in an electric vehicle, typically, the primary side is embedded in the ground, and the secondary side is disposed in a lower part of the electric vehicle. Thus, at the design stage of the wireless power feeding system, the capacitance of the serial capacitor Cs is determined by using the coupling coefficient at the distance between the primary coil L₁ and the secondary coil L₂ that is set in advance on a designer side in accordance with a certain criteria (e.g. information on vehicle height of the electric vehicle in which the wireless power feeding system is scheduled to be disposed, etc.).

Then, if the distance between the primary coil L₁ and the secondary coil L₂ becomes greater than its design value, i.e. if the coupling coefficient is less than its design value, as illustrated in the dashed line in FIG. 7, there is a possibility that the power supply effective utilization efficiency remarkably decreases.

In the wireless power feeding system 1 in the embodiment, however, the capacitance value of the variable capacitance capacitor 130 is controlled such that a phase difference between a voltage phase and a current phase of the alternating current power supply (i.e. the primary side), i.e. such that the primary side power factor approaches 1, on the basis of the coupling coefficient estimated by the coupling coefficient estimation unit 150. Thus, as shown by the solid line in FIG. 7, even if the distance between the power transmission coil 120 and the power reception coil 220 (i.e. corresponding to the distance between the primary coil L₁ and the secondary coil L₂) deviates from the design value, the decrease in the power supply effective utilization efficiency can be suppressed.

Specifically, as in the case explained by using FIG. 5, if the distance between the primary coil and the secondary coil becomes greater than the design value of 10 cm and the coupling coefficient decreases to 0.2, the capacitance value of the serial capacitor on the primary side is changed to Cs=0.082 according to the aforementioned (Equation 4). At this time, each of the time variations in primary side voltage V₁, secondary side voltage V₂, primary side current I₁ and secondary side current I₂ is, for example, as illustrated in FIG. 8. A point to note in FIG. 8 is that the phase of the primary side voltage V₁ matches the phase of the primary side current I₁ and that the primary side power factor is 1. At this time, the power supply effective utilization efficiency improves to 85.1%.

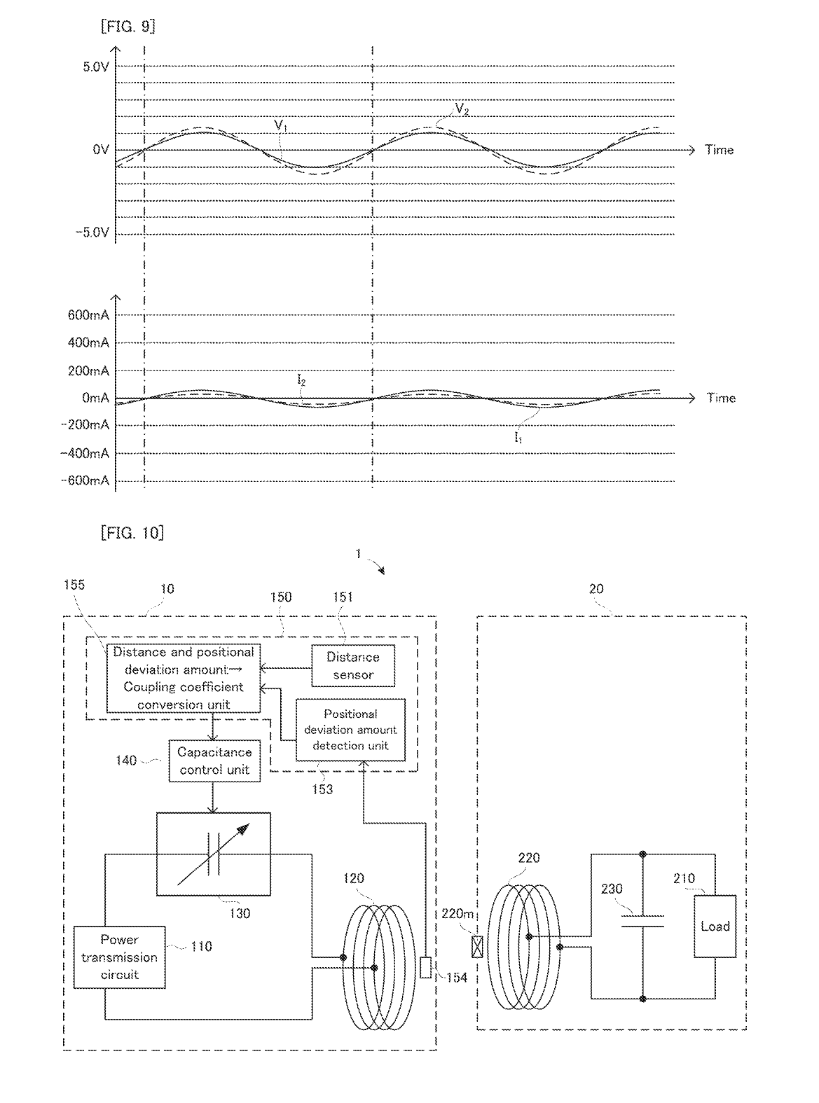

On the other hand, as in the case explained by using FIG. 6, if the distance between the primary coil and the secondary coil becomes less than the design value of 10 cm and the coupling coefficient increases to 0.7, the capacitance value of the serial capacitor on the primary side is changed to Cs=0.15 according to the aforementioned (Equation 4). At this time, each of the time variations in primary side voltage V₁, secondary side voltage V₂, primary side current I₁ and secondary side current I₂ is, for example, as illustrated in FIG. 9. A point to note in FIG. 9 is that the phase of the primary side voltage V₁ matches the phase of the primary side current I₁ and that the primary side power factor is 1. At this time, the power supply effective utilization efficiency improves to 96.3%.

Upper parts of FIG. 8 and FIG. 9 illustrate another example of each of the time variations in primary side voltage V₁ and secondary side voltage V₂, to the same effect as in the upper part of FIG. 4, and lower parts of FIG. 8 and FIG. 9 illustrate another example of each of the time variations in primary side current I₁ and secondary side current I₂, to the same effect as in the lower part of FIG. 4.

The “power transmitting apparatus 10”, the “capacitance control nit 140”, the “coupling coefficient estimation unit 150”, the “distance sensor 151”, and the “distance-coupling coefficient conversion unit 152” in the embodiment are one example of the “wireless power transmitting apparatus”, the “capacitance controlling device”, the “coupling estimating device”, the “distance measuring device”, and the “converting device” of the present invention, respectively.

### Second Embodiment

A second embodiment of the wireless power feeding system of the present invention will be explained with reference to FIG. 10. The second embodiment has the same configuration as that of the first embodiment, except that the configuration of the wireless power feeding system is partially different. Thus, in the second embodiment, a duplicated explanation of the first embodiment will be omitted, and common parts have the same reference numerals on the drawings. Basically, only a different point will be explained with reference to FIG. 10. FIG. 10 is a block diagram illustrating the configuration of the wireless power feeding system in the second embodiment, to the same effect as in FIG. 1.

In FIG. 10, the coupling coefficient estimation unit 150 is further provided with an imaging device 154 which is arranged, for example, on a surface of the power transmission coil 120 opposed to the power reception coil 220 and in the vicinity of the center of the power transmission coil 120, a positional deviation amount detection unit 153 which detects a positional deviation amount between the center of the power transmission coil 120 and the center of the power reception coil 220 on the basis of an image imaged by the imaging device 154, and a distance and positional deviation amount-coupling coefficient conversion unit 155 which obtains the coupling coefficient on the basis of the distance measured by the distance sensor 151 and the positional deviation amount detected by the positional deviation amount detection unit 153.

The power receiving apparatus 20 is provided with a mark 220m for positioning. The imaging device such as, for example, a charge coupled device (CCD) camera and an optical sensor images the mark 220m. The positional deviation amount detection unit 153 detects the positional deviation amount on the basis of the imaged mark 220m.

The distance and positional deviation amount-coupling coefficient conversion unit 155 stores therein information (a look-up table) which indicates the value of the coupling coefficient between the power transmission coil 120 and the power reception coil 220 when each of the distance and the positional deviation amount changes. The distance and positional deviation amount-coupling coefficient conversion unit 155 obtains the corresponding coupling coefficient from the lookup table on the basis of the distance measured by the distance sensor 151 and the positional deviation amount detected by the positional deviation amount detection unit 153.

The capacitance control unit 140 sets the capacitance value of the variable capacitance capacitor 130 according to the aforementioned (Equation 4) and the coupling coefficient obtained by the distance and positional deviation amount-coupling coefficient conversion unit 155.

The “positional deviation amount detection unit 153” in the embodiment is one example of the “positional deviation amount detecting device” of the present invention. The “distance and positional deviation amount-coupling coefficient conversion unit 155” in the embodiment is another example of the “converting device” of the present invention.

### Third Embodiment

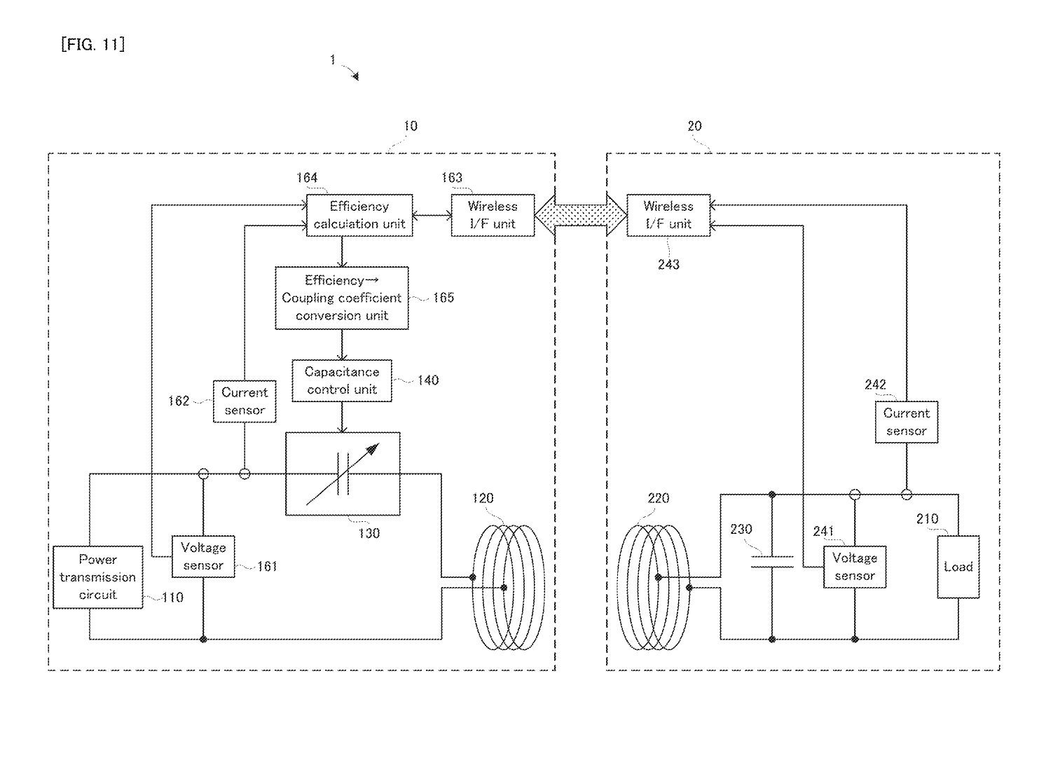

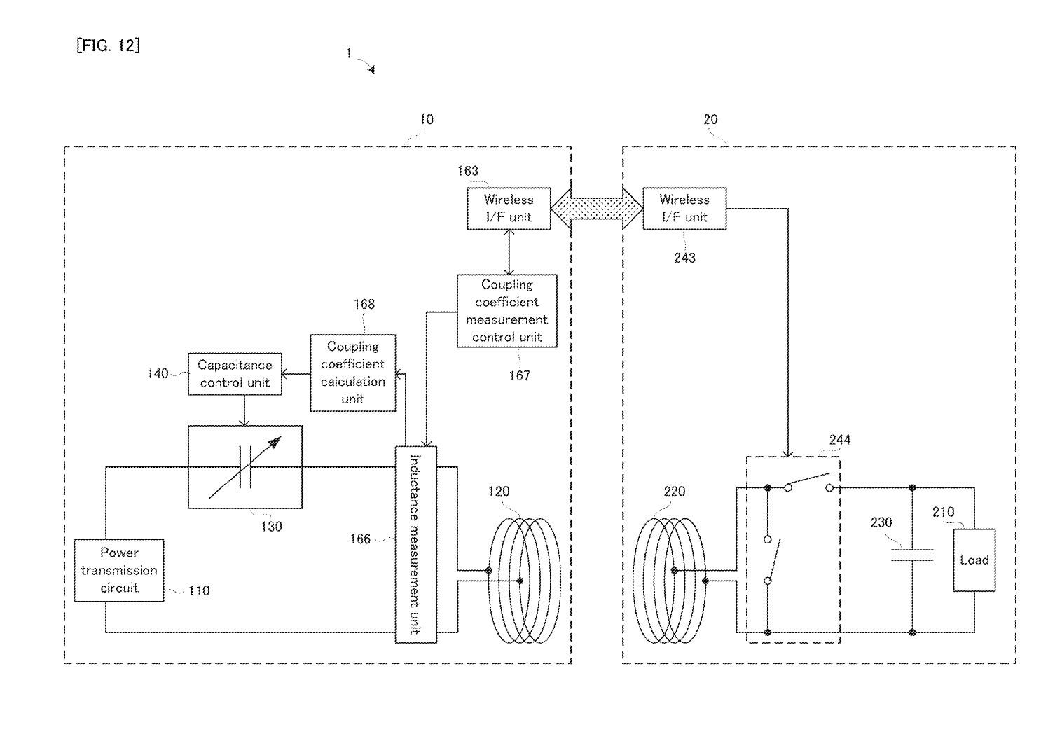

A third embodiment of the wireless power feeding system of the present invention will be explained with reference to FIG. 11. The third embodiment has the same configuration as that of the first embodiment, except that the configuration of the wireless power feeding system is partially different. Thus, in the third embodiment, a duplicated explanation of the first embodiment will be omitted, and common parts have the same reference numerals on the drawings. Basically, only a different point will be explained with reference to FIG. 11. FIG. 11 is a block diagram illustrating the configuration of the wireless power feeding system in the third embodiment, to the same effect as in FIG. 1.

In FIG. 11, the power receiving apparatus 20 is further provided with a voltage sensor 241 which measures a voltage value of the power receiving apparatus 20, a current sensor 242 which measures a current value of the power receiving apparatus 20, and a wires interface (I/F) unit 243 which transmits the measured voltage value and current value to the power transmitting apparatus 10.

On the other hand, the power transmitting apparatus 10 is further provided with a voltage sensor 161 which detects a voltage value of the alternating current power, a current sensor 162 which detects a current value of the alternating current power, a wires interface unit 163, an efficiency calculation unit 164 which calculates power transmission efficiency, and an efficiency-coupling coefficient conversion unit 165 which converts the calculated power transmission efficiency to the coupling coefficient.

The efficiency calculation unit 164 calculates the power transmission efficiency on the basis of at least one of the voltage value detected by the voltage sensor 161 and the current value detected by the current sensor 162, and at least one of the voltage value and the current value of the power receiving apparatus 20 which are obtained via the wireless interface unit 163.

The efficiency-coupling coefficient: conversion unit 165 stores therein information which indicates a correspondence between the power transmission efficiency and the coupling coefficient, in advance. Then, the efficiency-coupling coefficient conversion unit 165 converts the calculated power transmission efficiency to the coupling coefficient, on the basis of the information Which indicates the correspondence between the power transmission efficiency and the coupling coefficient. The information which indicates the correspondence between the power transmission efficiency and the coupling coefficient may be established, for example, on the basis of a relation of the power transmission efficiency with the self-inductance and leakage inductance of the power transmission coil 120, wherein the relation is obtained by experiments or simulations while changing the distance between the primary coil and the secondary coil, wherein the value of the primary serial capacitor is fixed to a predetermined value.

The “voltage sensor 161” and the “current sensor 162” in the embodiment are one example of the “detecting device” of the present invention. The “wireless interface unit 163” and the “efficiency calculation unit 164” in the embodiment are one example of the “obtaining device” and the “calculating device” of the present invention, respectively. The “efficiency-coupling coefficient conversion unit 165” in the embodiment is another example of the “converting device” of the present invention.

### Fourth Embodiment

A fourth embodiment of the wireless power feeding system of the present invention will be explained with reference to FIG. 12. The fourth embodiment has the same configuration as that of the third embodiment, except that the configuration of the wireless power feeding system is partially different. Thus, in the fourth embodiment, a duplicated explanation of the third embodiment will be omitted, and common parts have the same reference numerals on the drawings. Basically, only a different point will be explained with reference to FIG. 12. FIG. 12 is a block diagram illustrating the configuration of the wireless power feeding system in the fourth embodiment, to the same effect as in FIG. 1.

In FIG. 12, the power receiving apparatus 20 is further provided with a secondary coil open and short-circuit unit 244 which can open or short-circuit the power reception coil 220.

On the other hand, the power transmitting apparatus 10 is further provided with (i) an inductance measurement unit 166, (ii) a coupling coefficient measurement control unit. 67 which controls the secondary coil open and short-circuit unit 244 via the wireless interface unit 163 and which also controls the inductance measurement unit 166, and (iii) a coupling coefficient calculation unit 108 which calculates the coupling coefficient on the basis of inductance measured by the inductance measurement unit 166.

A method of obtaining the coupling coefficient in the embodiment is based on the method of measuring the coupling coefficient provided in JIS-C5321.

Specifically, for example, the coupling coefficient measurement control unit 167 firstly controls the secondary coil open and short-circuit unit 244 to open the power reception coil 220 via the wireless interface unit 163. At this time, an inductance value (Lopen) of the power transmission coil 120 is measured by the inductance measurement unit 166.

Then, the coupling coefficient measurement control unit 167 firstly controls the secondary coil open and short-circuit unit 244 to short-circuit the power reception coil 220 via the wireless interface unit 163. At this time, an inductance value (Lshort) of the power transmission coil 120 is measured by the inductance measurement unit 166.

Then, the coupling coefficient calculation unit 168 calculates the coupling coefficient according to the following (Equation 5) on the basis of the two measured inductance values (“Lopen” and “Lshort”).

$$k = \sqrt{1 - \frac{L short}{L open}} \qquad ( Equation 5 )$$

The capacitance control unit 140 sots the capacitance value of the variable capacitance capacitor 130 according to the aforementioned (Equation 4) by using the coupling coefficient calculated by the coupling coefficient calculation unit 168.

### Fifth Embodiment

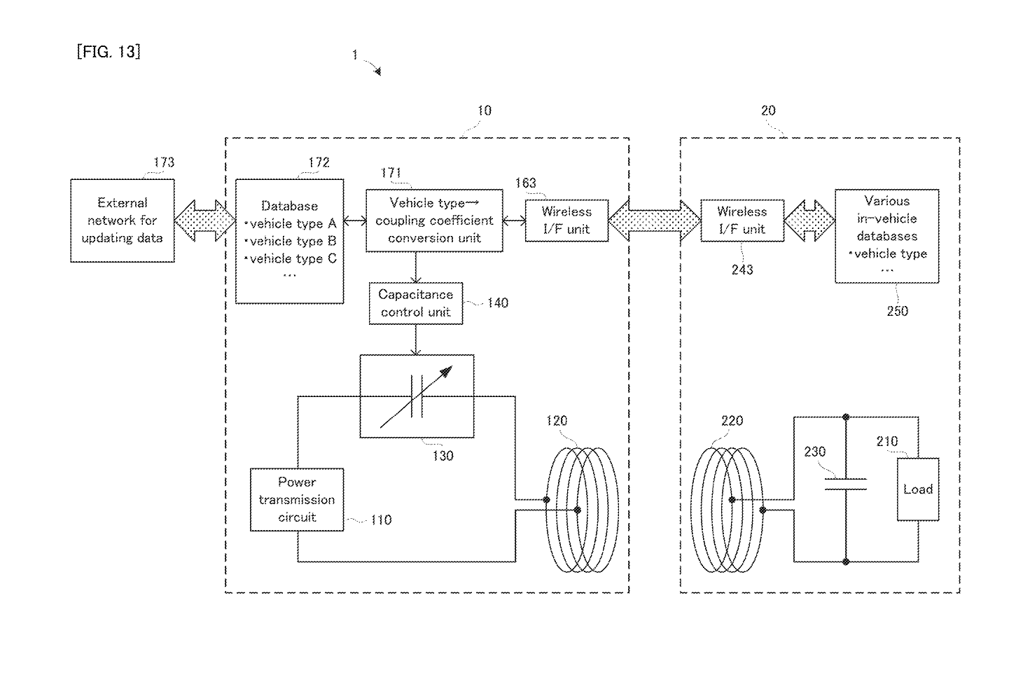

A fifth embodiment of the wireless power feeding system of the present invention will be explained with reference to FIG. 13. The fifth embodiment has the same configuration as that of the first embodiment, except that the configuration of the wireless power feeding system is partially different. Thus, in the fifth embodiment, a duplicated explanation of the first embodiment will be omitted, and common parts have the same reference numerals on the drawings. Basically, only a different point will be explained with reference to FIG. 13. FIG. 13 is a block diagram illustrating the configuration of the wireless power feeding system in the fifth embodiment, to the same effect as in FIG. 1. Particularly in the fifth embodiment, it is assumed that the power receiving apparatus 20 is disposed in an electric vehicle which is one example of the “moving both” of the present invention.

In FIG. 13, the power receiving apparatus 20 is further provided with (i) a database 250 which stores therein information about the electric vehicle in which the power receiving apparatus is disposed, and (ii) a wireless interface unit 243 which transmits to the power transmitting apparatus 10 at least information which indicates a vehicle type of the electric vehicle, out of the information stored in the database 250.

On the other hand, the power transmitting apparatus 10 is further provided with a wireless interface unit 163, a database 172 which stores therein information about various vehicle types in advance, and a vehicle type-coupling coefficient conversion unit 171 which obtains the coupling coefficient on the basis of the information about the vehicle type.

The vehicle type-coupling coefficient conversion unit 171 obtains information about a relevant vehicle type (e.g. a vehicle height value) from the information about various vehicle types stored in the database 172, on the basis of the information which indicates the vehicle type of the electric vehicle in which the power receiving apparatus 20 is disposed and which is obtained via the wireless interface unit 163, and then obtains the coupling coefficient on the basis of the obtained information about the relevant vehicle type.

The database 172 is configured to access a server apparatus on an external network 173 such as, for example, the Internet, by a wireless local area network (LAN) or the like and to update at least one of the stored plurality of pieces of information about various vehicle types.

The “wireless interface unit 163” in the embodiment is one example of the “type obtaining device” of the present invention. The “vehicle type-coupling coefficient conversion unit 171” in the embodiment is another example of the “converting device” of the present invention.

### Sixth Embodiment

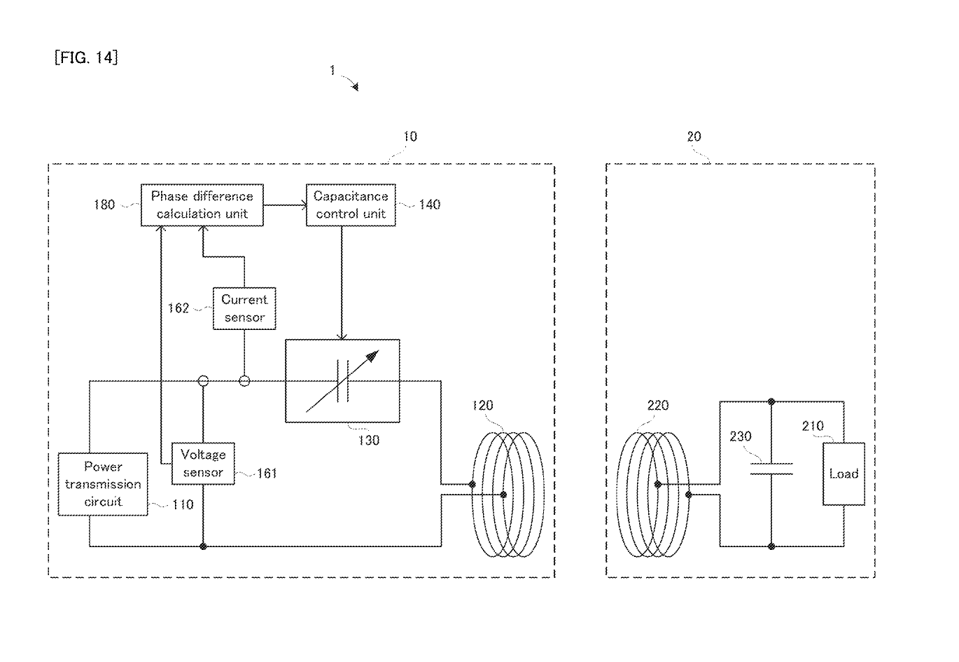

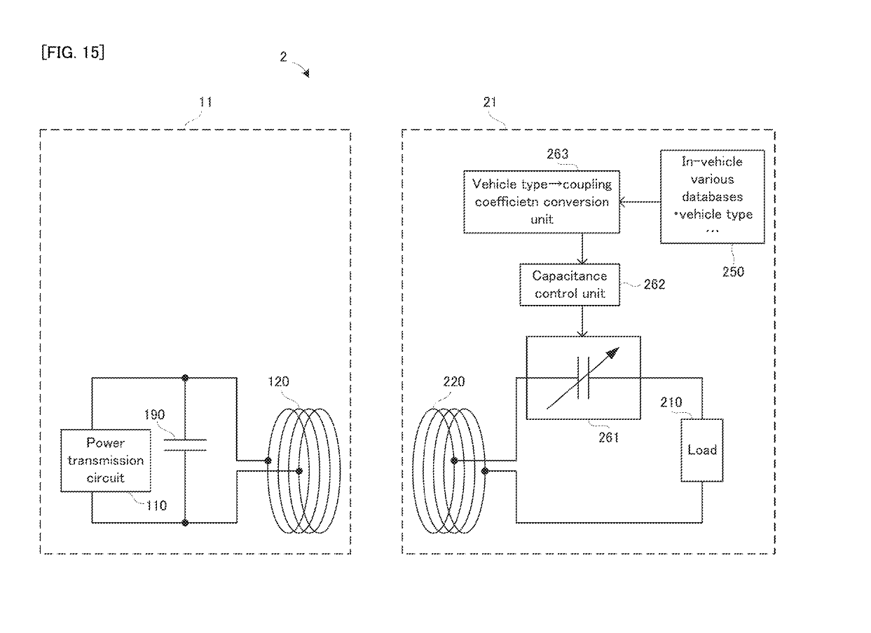

A sixth embodiment of the wireless power feeding system of the present invention will be explained with reference to FIG. 14. The sixth embodiment has the same configuration as that of the first embodiment, except that the configuration of the wireless power feeding system is partially different. Thus, in the sixth embodiment, a duplicated explanation of the first embodiment: will be omitted, and common parts have the same reference numerals on the drawings. Basically, only a different: point will be explained with reference to FIG. 14. FIG. 14 is a block diagram illustrating the configuration of the wireless power feeding system in the sixth embodiment, to the same effect as in FIG. 1.

In FIG. 14, the power transmitting apparatus 10 is further provided with a voltage sensor 161 which detects a voltage value of the alternating current power, a current sensor 162 which detects a current value of the alternating current power, a wires interface unit 163, and a phase difference calculation unit 180 which calculates a phase difference between the phase of the voltage value and the phase of the current value.

The capacitance control unit 140 controls the capacitance value of the variable capacitance capacitor 130 to reduce the phase difference calculated by the phase difference calculation unit 180.

The “phase difference calculation unit 180” in the embodiment is one example of the “voltage phase detecting device” and the “current phase detecting device” of the present invention.

### Seventh Embodiment

A seventh embodiment of the wireless power feeding system of the present invention will be explained with reference to FIG. 15. The seventh embodiment has the same configuration as that of the first embodiment, except that the configuration of the wireless power feeding system is partially different. Thus, in the seventh embodiment, a duplicated explanation of the first embodiment will be omitted, and common parts have the same reference numerals on the drawings. Basically, only a different point will be explained with reference to FIG. 15. FIG. 15 is a block diagram illustrating the configuration of the wireless power feeding system in the seventh embodiment, to the same effect as in FIG. 1.

In FIG. 15, a wireless power feeding system 2 is provided with a power transmitting apparatus 11 and a power receiving apparatus 21.

The power transmitting apparatus 11 is provided with a power transmission circuit 110, a power transmission coil electrically connected to the power transmission circuit 110, and a fixed capacitance capacitor 190 electrically connected in parallel with the power transmission coil 120.

The power receiving apparatus 21 is provided with (i) a load 210, (ii) a power reception coil 220 electrically connected to the load 210, (iii) a variable capacitance capacitor 261 electrically connected in series with the power reception coil 220, (iv) a database 250 which stores therein information about an electric vehicle in which the power receiving apparatus 21 is disposed a vehicle type-coupling coefficient conversion unit 263 which obtains a coupling coefficient on the basis of information about a vehicle type of the electric vehicle, out of the information stored in the database 250, and (vi) a capacitance control unit 262 which controls a capacitance value of the variable capacitance capacitor 261 on the basis of the obtained coupling coefficient.

The “power receiving apparatus 21” in the embodiment is one example of the “wireless power receiving apparatus” of the present invention.

The present invention is not limited to the aforementioned embodiments, but various changes may be made, if desired, without departing from the essence or spirit of the invention which can be read from the claims and the entire specification a wireless power transmitting apparatus, a wireless power receiving apparatus, and a wireless power feeding system which involve such changes are also intended to be within the technical scope of the present invention.

### DESCRIPTION OF REFERENCE CODES

1, 2 wireless power feeding system
10, 11 power transmitting apparatus
20, 21 power receiving apparatus
110 power transmission circuit
120 power transmission coil
130, 261 variable capacitance capacitor
140, 262 capacitance control unit
190, 230 fixed capacitance capacitor
210 load
220 power reception coil

1. A wireless power receiving apparatus which receives electric power transmitted from a power transmitting apparatus in a wireless manner by electromagnetic induction, said wireless power receiving apparatus comprising:
a power reception coil;
a variable capacitance capacitor which is electrically connected with the power reception coil;
a storing device configured to store therein type of a moving body in which said wireless power receiving apparatus is disposed; and
a capacitance controlling device configured to control capacitance of the variable capacitance capacitor on the basis of the type stored in the storing device.

2. The wireless power receiving apparatus according to claim 1, wherein
said wireless power receiving apparatus further comprises a coupling coefficient conversing device configured to convert the type of the moving body into a coupling coefficient indicating extent of magnetic coupling of a power transmission coil of the power transmitting apparatus and the power reception coil, and
the capacitance controlling device controls the capacitance of the variable capacitance capacitor on the basis of the converted coupling coefficient.

3. The wireless power receiving apparatus according to claim 2, wherein
the storing device is a database configured to store therein information of an electric vehicle in which said wireless power receiving apparatus is disposed, and
the type of the moving body is information which is included in the information, stored in the database, and which indicates a vehicle type of the electric vehicle in which said wireless power receiving apparatus is disposed.

4. A control method in a wireless power receiving apparatus which has a power reception coil, a variable capacitance capacitor electrically connected with the power reception coil and a type storing device configured to store therein type of a moving body, and which receives electric power transmitted from a power transmitting apparatus in a wireless manner by electromagnetic induction, said control method comprising:
a obtaining process which obtains the type stored in the type storing device; and
a capacitance controlling process which controls capacitance of the variable capacitance capacitor on the basis of obtained type.

5. The control method according to claim 4, wherein
said control method further comprises a coupling coefficient conversing process which converts the type of the moving body into a coupling coefficient indicating extent of magnetic coupling of a power transmission coil of the power transmitting apparatus and the power reception coil, and
the capacitance controlling process controls the capacitance of the variable capacitance capacitor on the basis of the converted coupling coefficient.

6. The control method according to claim 5, wherein
the storing device is a database configured to store therein information of an electric vehicle in which said wireless power receiving apparatus is disposed, and
the type of the moving body is information which is included in the information stored in the database, and which indicates a vehicle type of the electric vehicle in which said wireless power receiving apparatus is disposed.
